(19) United States
(12) Patent Application Publication
(10) Pub. No.: US 2024/0054553 A1
(43) Pub. Date: Feb. 15, 2024

(54) SHOP DATA PROCESSING APPARATUS, SHOP DATA PROCESSING METHOD, AND NON-TRANSITORY STORAGE MEDIUM

(71) Applicant: NEC Corporation, Minato-ku, Tokyo (JP)

(72) Inventors: Rina Tomita, Tokyo (JP); Yuji Tahara, Tokyo (JP)

(73) Assignee: NEC Corporation, Minato-ku (JP)

(21) Appl. No.: 18/273,214

(22) PCT Filed: Jun. 30, 2021
(86) PCT No.: PCT/JP2021/024774

§ 371 Date: Jul. 19, 2023

(51) Int. Cl. G06Q 30/0601

(52) U.S. Cl. CPC G06Q 30/0641

(57) ABSTRACT

The sales data acquisition unit (110) acquires sales data and discard data. The sales data indicate at least one of a number of sales and a number of preparations of a product in a first shop for each unit period. The discard data indicate a number of discards of the product for the each unit period. The customer data acquisition unit (120) acquires customer data. The customer data indicate at least one of a number of customers in the first shop and a traffic amount of a first area for the each unit period. The first area is an area including the first shop. The relevance data generation unit (130) generates relevance data indicating relevance among the sales data, the discard data, and the customer data, and displays the relevance data on a display (150).

### TECHNICAL FIELD

The present invention relates to a shop data processing apparatus, a shop data processing method, and a program.

### BACKGROUND ART

In a product to be sold in a shop, there are a large number of products being set a best-before date or an expiration date. When a number of purchases of such a product or a number of cooking in a shop is too large, the number of products to be discarded increases. On the other hand, when these numbers are too small, a sales opportunity will be lost. For this reason, in order to improve an operation state of a shop, it is desired to make the number of purchases of products and the number of cooking in the shop appropriate.

In response to such a request, Patent Document 1 discloses a forecast model that reduces an opportunity loss. The forecast model computes a forecast value of demand for a product by using demand information indicating a number of sales of products in a shop in a past and external information relating to the number of sales. The external information includes, for example, information on a time or a time period, a day of the week or a holiday, temperature, weather, and a number of visitors.

In addition, a system described in Patent Document 2, based on sales performance data in a latest period in a past, for each product, computes an expected profit for each individual up to a specific number of each product, sorts a computation result of all products in descending order of the expected profit, and thereby computes an optimum order pattern, based on the sort result.

### RELATED DOCUMENT

### Patent Document

Patent Document 1: International Patent Publication No. WO2019/159772
Patent Document 2: Japanese Patent Application Publication No. 2002-297958

### DISCLOSURE OF THE INVENTION

### Technical Problem

In many cases, a shop clerk determines a number of purchases of a product and a number of cooking in a shop. For this reason, it is important to make a shop clerk recognize validity of the number of purchases of the product and the number of cooking in the shop. One example of an object of the present invention is to make it easy for a shop clerk to recognize validity of a number of purchases of a product and a number of cooking in a shop.

### Solution to Problem

One aspect of the present invention provides a shop data processing apparatus including:
a sales data acquisition unit that acquires sales data indicating at least one of a number of sales and a number of preparations of a product in a first shop for each unit period, and discard data indicating a number of discards of the product for the each unit period;
a customer data acquisition unit that acquires customer data indicating at least one of a number of customers of the first shop and a traffic amount of a first area including the first shop for the each unit period; and
a relevance data generation unit that generates relevance data indicating relevance among the sales data, the discard data, and the customer data, and displays the relevance data on a display.

One aspect of the present invention provides a shop data processing apparatus including:
a supposed data acquisition unit that acquires supposed data including at least one of a supposed number of customers of a first shop and a supposed traffic amount of a first area including the first shop in a first period being in future;
a performance data acquisition unit that acquires performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
a recommendation number determination unit that determines, by using the supposed data and the performance data, a recommendation number indicating a number of the products to be prepared in the first shop in the first period.

One aspect of the present invention provides a shop data processing method including, by a computer to execute:
sales data acquisition processing of acquiring sales data indicating at least one of a number of sales and a number of preparations of a product in a first shop for each unit period, and discard data indicating a number of discards of the product for the each unit period;
customer data acquisition processing of acquiring customer data indicating at least one of a number of customers of the first shop and a traffic amount of a first area including the first shop for the each unit period; and
relevance data generation processing of generating relevance data indicating relevance among the sales data, the discard data, and the customer data, and displaying the relevance data on a display.

One aspect of the present invention provides a shop data processing method including, by a computer to execute:
supposed data acquisition processing of acquiring supposed data including at least one of a supposed number of customers of a first shop and a supposed traffic amount of a first area including the first shop in a first period being in future;
performance data acquisition processing of acquiring performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
recommendation number determination processing of determining, by using the supposed data and the performance data, a recommendation number indicating a number of the products to be prepared in the first shop in the first period.

One aspect of the present invention provides a program causing a computer to include:
a sales data acquisition function of acquiring sales data indicating at least one of a number of sales and a number of preparations of a product in a first shop for each unit period, and discard data indicating a number of discards of the product for the each unit period;
a customer data acquisition function of acquiring customer data indicating at least one of a number of customers of the first shop and a traffic amount of a first area including the first shop for the each unit period; and
a relevance data generation function of generating relevance data indicating relevance among the sales data, the discard data, and the customer data, and displaying the relevance data on a display.

One aspect of the present invention provides a program causing a computer to include:
a supposed data acquisition function of acquiring supposed data including at least one of a supposed number of customers of a first shop and a supposed traffic amount of a first area including the first shop in a first period being in future;
a performance data acquisition function of acquiring performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
a recommendation number determination function of determining, by using the supposed data and the performance data, a recommendation number indicating a number of the products to be prepared in the first shop in the first period.

### Advantageous Effects of Invention

According to one aspect of the present invention, a shop clerk easily recognize validity of a number of purchases of a product and a number of cooking in a shop.

### BRIEF DESCRIPTION OF THE DRAWINGS

The above-described object and other objects, features and advantageous effects will become more apparent from the following description of the preferred example embodiments and the accompanying drawings thereof.

FIG. 1 It is a diagram illustrating one example of a functional configuration of a shop data processing apparatus according to a first example embodiment.

FIG. 2 It is a diagram illustrating one example of a screen being displayed on a display by a relevance data generation unit.

FIG. 3 It is a diagram for describing a method of selecting a plurality of similar shops.

FIG. 4 It is a diagram for describing one example of a location condition.

FIG. 5 It is a diagram illustrating a modification example of a data display field illustrated in FIG. 2.

FIG. 6 It is a diagram illustrating one example of a method of selecting a second shop.

FIG. 7 It is a diagram illustrating one example of a method of selecting a second shop.

FIG. 8 It is a diagram illustrating a hardware configuration example of the shop data processing apparatus.

FIG. 9 It is a flowchart illustrating one example of processing performed by the shop data processing apparatus.

FIG. 10 It is a diagram illustrating one example of a functional configuration of a shop data processing apparatus according to a second example embodiment.

### DESCRIPTION OF EMBODIMENTS

Hereinafter, example embodiments of the present invention will be described with reference to the drawings. Note that, in all the drawings, a similar component is denoted by a similar reference sign, and description thereof will be omitted as appropriate.

### First Example Embodiment

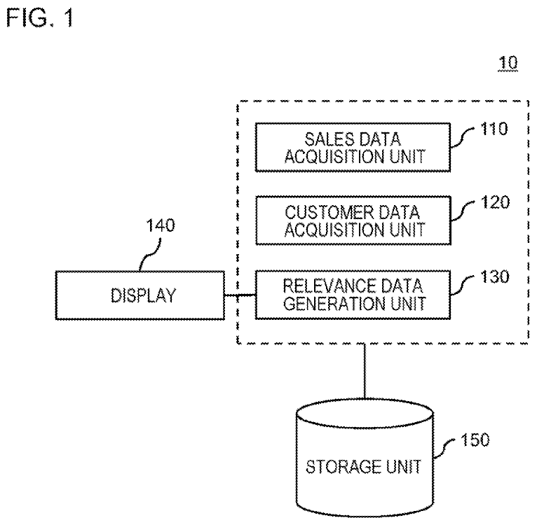

FIG. 1 is a diagram illustrating one example of a functional configuration of a shop data processing apparatus 10 according to the present example embodiment. The shop data processing apparatus 10 causes a display 140 to display related to at least one of a number of sales and a number of preparations of a product, for example, a food, in a target shop (hereinafter, referred to as a first shop), and a number of discards of the product. At this time, the shop data processing apparatus 10 also displays a number of visitors to the first shop or a traffic amount around the first shop.

Herein, the number of sales may be any piece of information being capable of determining the number of sold products. For example, the number of sales may be the number of sold products itself, or may be an amount of the sold product (i.e., a sales amount). In addition, one example of the number of preparations is the number of purchases. However, in a case where a target product is a food to be cooked in a shop, the number of preparations is the number of cooking of the product. The number of preparations may be any piece of information being capable of determining the number of prepared products. For example, the number of preparations may be the number of prepared products itself, or may be an amount of the prepared product. The number of discards may be any piece of information capable of determining the number of discarded products. For example, the number of discards may be the number of discarded products itself, or may be a discarded amount of the discarded product.

The shop data processing apparatus 10 includes a sales data acquisition unit 110, a customer data acquisition unit 120, and a relevance data generation unit 130. In addition, the shop data processing apparatus 10 can use information stored in a storage unit 150. The storage unit 150 may be a part of the shop data processing apparatus 10, or may be located outside the shop data processing apparatus 10.

The sales data acquisition unit 110 acquires sales data and discard data. The sales data indicate at least one of the number of sales and the number of preparations of a product in the first shop for each unit period. The discard data indicate the number of discards of a product for each unit period. The unit period may be, for example, a quarter unit, a month unit, a week unit, or a day unit. When the unit period is a day unit, the sales data and the discard data may further indicate each number for each time period. Then, the sales data and the discard data include each number in a predetermined period (hereinafter, referred to as a target period) longer than the above-described unit period. The target period includes a plurality of unit periods described above. When the unit period is a quarter unit or a month unit, one example of the target period is one year. In addition, when the unit period is a week unit, one example of the target period is a month or a quarter. In addition, when the unit period is a day unit, one example of the target period is a week or a month. The sales data and the discard data are stored in the storage unit 150.

In addition, the sales data acquisition unit 110 acquires, from a shop clerk, information (hereinafter, product specification information) specifying a product to be subjected to the sales data and the discard data. In other words, the sales data acquisition unit 110 also serves as a product specification acquisition unit that acquires product specification information. The sales data acquisition unit 110 further acquires, from the shop clerk, information (hereinafter, referred to as period specification information) specifying the above-described predetermined period.

The customer data acquisition unit 120 acquires customer data. The customer data indicate at least one of a number of customers in the first shop and a traffic amount of a first area for each unit period. The first area is an area including the first shop, and is, for example, an area in which a required time from the shop on foot is within a predetermined time (e.g., within 10 minutes). The customer data are stored in the storage unit 150. Note that, the unit period used herein is the same as the unit period used in the sales data and the discard data. Then, the customer data includes each number in the above-described target period.

The relevance data generation unit 130 generates relevance data. The relevance data are data for causing a shop clerk to recognize relevance among the sales data, the discard data, and the customer data in the target period, and indicates, for example, the relevance thereof. Then, the relevance data generation unit 130 displays the relevance data on the display 140.

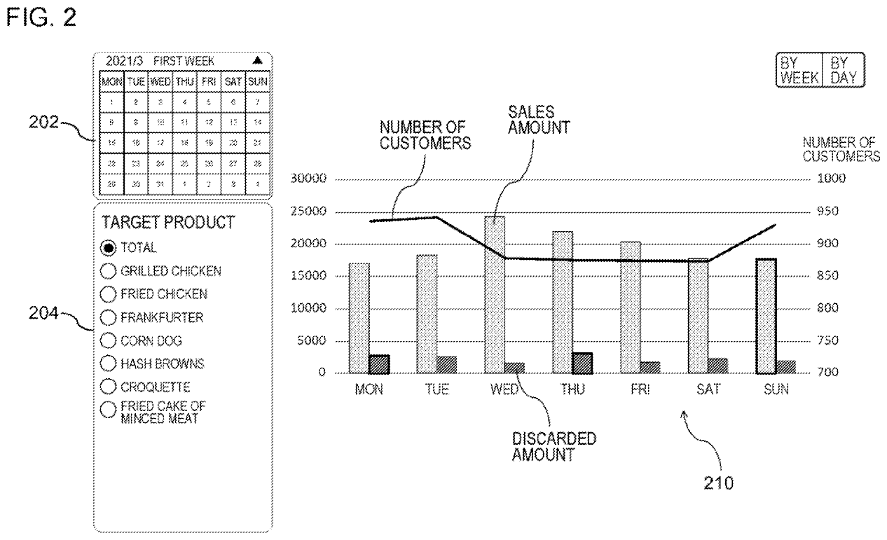

FIG. 2 is a diagram illustrating one example of a screen displayed on the display 140 by the relevance data generation unit 130. The screen includes a period selection field 202, a product selection field 204, and a data display field 210.

The period selection field 202 is a field for a shop clerk to input period specification information. In the example illustrated in the present figure, the period selection field 202 is capable of selecting a month date as a start point and a month date as an end point of the target period.

The product selection field 204 is a field for a shop clerk to select a product for which the sales data and the discard data are to be confirmed. In the product selection field 204, a plurality of products can be selected. Then, the sales data acquisition unit 110 acquires information indicating the product selected in the product selection field 204 as product specification information.

The data display field 210 is a field in which relevance data are displayed. In the example illustrated in the present figure, the relevance data indicate a transition of at least one of the number of customers and a traffic amount, at least one of the number of sales and the number of preparations, and the number of discards. More specifically, the relevance data include a graph simultaneously indicating the number of sales (a sales amount in the example in the present figure), the number of discards (a discarded amount in the example in the present figure), and the number of customers. In the graph, a horizontal axis indicates a unit period. In other words, the graph illustrates each number for each unit period. Then, the number of sales and the number of discards are indicated by a bar graph, and the number of customers is indicated by a line graph. However, a form of the graph is not limited to the example.

In the example illustrated in the present figure, the unit period is a day unit. Then, the horizontal axis of the graph indicates a day of the week. In other words, the graph can recognize relevance among at least one of the number of customers and the traffic amount, at least one of the number of sales and the number of preparations, and the number of discards, for each day of the week.

Then, by viewing the data display field 210, a shop clerk can recognize an attribute (e.g., a day of the week or a time period) of a unit period in which a sale is small even though the number of customers is large. In such a unit period, when the number of preparations of a product is increased, a sales amount of the product may also increase. For this reason, a shop clerk considers increasing the number of preparations in a unit period having the same attribute as the unit period.

Further, by viewing the data display field 210, a shop clerk can recognize an attribute (e.g., a day of the week or a time period) of a unit period in which the number of customers is small and the number of discards is large. In such a unit period, even when the number of preparations of a product is reduced, a sales amount of the product may not decrease. For this reason, a shop clerk considers reducing the number of preparations in a unit period having the same attribute as the unit period.

Note that, in the data display field 210, the relevance data generation unit 130 preferably displays a unit period (hereinafter, referred to as a specific period) satisfying a predetermined condition in an aspect different from another unit period. The specific period may be indicated by a pattern or color different from another period, or may be given a specific mark, frame, or character. This makes it easier for a shop clerk to recognize the specific period.

One example of the predetermined condition is “that the number of preparations needs to be changed”. The change herein may be an increase or a decrease.

For example, the predetermined condition is at least one of the following.
1) a ratio of at least one of the number of customers and the traffic amount, and at least one of the number of sales and the number of preparations satisfies a reference
2) the discard data satisfy a reference

The above-described 1) is, for example, that the ratio is out of a reference range. The reference range is determined, for example, by using performance values of a plurality of shops (hereinafter, referred to as similar shops) whose condition is similar to that of the first shop. A specific example of a “condition is similar” will be described later.

The above-described 2) is, for example, that a piece of discard data is equal to or larger than a reference value. The reference value is also determined, for example, by using performance values of a plurality of similar shops.

The shop data processing apparatus 10 may be installed in the first shop, or may be installed in a management center that manages a plurality of shops. In the latter case, the display 140 is connected to a terminal installed in the first shop. Then, the relevance data generation unit 130 transmits the relevance data to a shop terminal.

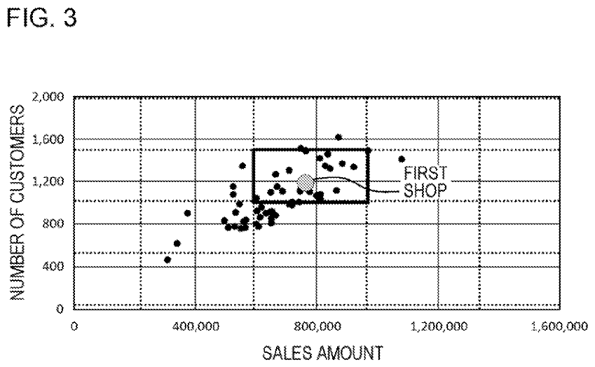

FIG. 3 is a diagram for describing a method of selecting a similar shop from a plurality of shops. The plurality of shops are performed clustering in advance by using a plurality of conditions. A clustering population is, for example, a shop having a similar location condition in a local government (prefecture or municipality) to which the first shop belongs. Then, each of the plurality of shops belonging to the same cluster as the first shop is selected as a similar shop. Information determining the population is stored in the storage unit 150.

In the example illustrated in the present figure, the condition used in clustering relates to a sales trend. One example of the condition related to the sales trend is the number of customers and a sales amount. The sales amount may be a sales amount per shop, or may be a sales amount of a product indicated by product specification information.

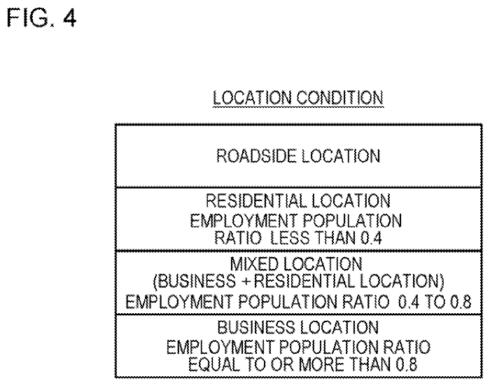

FIG. 4 is a diagram for describing one example of a location condition. The location condition is, first, classified according to whether to be located on a roadside, for example, whether to be facing a trunk road. Further, a shop not being located on the roadside is further classified by using an employment population ratio. One example of the employment population ratio is “employment population around a shop”/“(number of households around the shop)+(employment population around the shop)”. Note that, “around a shop” is within a certain range from the shop, for example, within a predetermined time on foot from the shop. In the example illustrated in the present figure, a shop not being located on the roadside is classified into any of three groups of a residential location, a mixed location, and a business location.

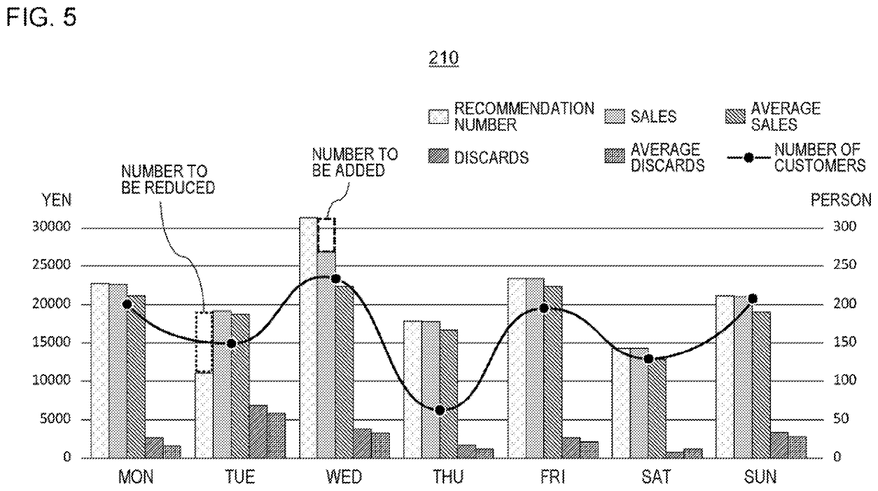

FIG. 5 is a diagram illustrating a modification example of the data display field 210 illustrated in FIG. 2. In the example illustrated in the present figure, the relevance data generation unit 130 further displays, in the data display field 210, information capable of determining a recommendation number of the number of preparations in the specific period.

In the example illustrated in the present figure, the relevance data generation unit 130 computes the recommendation number of each of a plurality of unit periods included in the graph. A method of computing the recommendation number will be described later. Then, the relevance data generation unit 130 also displays the recommendation number in the graph. In the example illustrated in the present figure, the recommendation number is illustrated in an aspect similar to the number of sales and the number of discards, for example, in a bar graph.

In addition, the relevance data generation unit 130 displays, in the graph, information (hereinafter, referred to as difference information) indicating a difference in the unit period in which the difference between the recommendation number and the number of preparations is equal to or greater than a reference value. In the example illustrated in the present figure, the difference information is displayed as a bar that fills the difference on a smaller bar graph between the number of preparations and the recommendation number. In addition, the relevance data generation unit 130 displays the difference, in a different aspect between a case where the number of preparations is smaller than the recommendation number and a case where the number of preparations is larger than the recommendation number. The aspect herein includes at least one of color, a pattern, and an outline.

Herein, the relevance data generation unit 130 sets the recommendation number by using performance values of a plurality of shops (hereinafter, referred to as a second shop) having a high sales amount and a small number of discards, among the shops belonging to the same cluster as the first shop (i.e., the similar shop described above). Specifically, the relevance data generation unit 130 computes the recommendation number by a multiple regression analysis using the performance value of the second shop. In the multiple regression analysis, an objective variable is the number of sales (e.g., the number of sales for each time period). In addition, one example of an explanatory variable is an attribute (e.g., day of the week) of the unit period, the number of customers, and the traffic amount of an area to which the shop belongs. Data used for the multiple regression analysis are stored in the storage unit 150.

When the above-described multiple regression analysis is used, supposed data including at least one of the number of customers of the first shop in the unit period and the traffic amount of the first area are required. The relevance data generation unit 130 computes the supposed data by using the number of customers in a past and a performance of the traffic amount in the first area. The performance used herein is a performance in a period (e.g., the same day of the week) having the same attribute as the unit period. Note that, the number of the second shops may be one or plural.

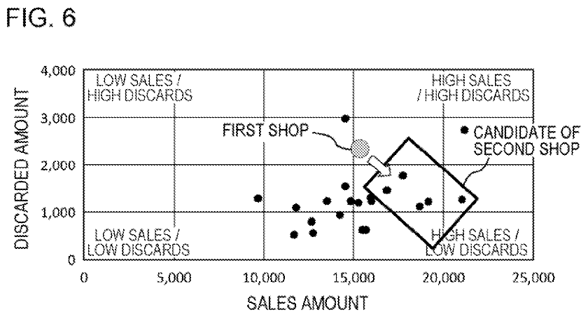

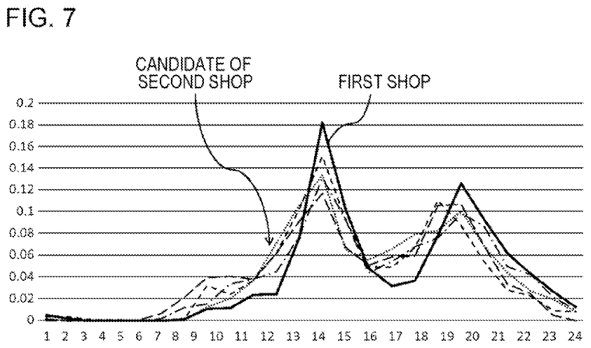

FIGS. 6 and 7 are diagrams illustrating one example of a method of selecting the second shop. FIG. 6 illustrates a result of plotting a plurality of shops belonging to the same cluster as the first shop (i.e., a plurality of similar shops) on a graph having two axes of the sales amount and the discarded amount. The sales amount and the discarded amount relate to a product indicated by the product specification information. The relevance data generation unit 130 selects, as a candidate for the second shop, a plurality of shops of which the sales amount is higher than that of the first shop and the discarded amount is lower than that of the first shop, among the plurality of similar shops.

Then, the relevance data generation unit 130 selects, as the second shop, a shop in which a sales trend for each time period is similar to that of the first shop, among the selected candidates, as illustrated in FIG. 7. As one example, the relevance data generation unit 130 decides that a degree of similarity is high when the time periods in which the number of sales is the largest are the same in each of the daytime and the nighttime. Then, the relevance data generation unit 130 selects a shop having a higher degree of similarity as the second shop. The number of shops selected herein may be one or plural.

Note that, in the example illustrated in FIG. 2 or 5, the relevance data generation unit 130 may display, also for the above-described second shop, similar relevance data (e.g., a graph) to that of the first shop in the data display field 210 simultaneously with the relevance data of the first shop. In this case, the sales data acquisition unit 110 and the customer data acquisition unit 120 also perform, for the second shop, similar processing to that of the first shop. Note that, in the example illustrated in FIG. 5, the graph relating to the second shop may not be necessary to include information capable of determining the recommendation number. When the data display field 210 performs such display, a shop clerk of the first shop can easily recognize a difference between the first shop and the second shop.

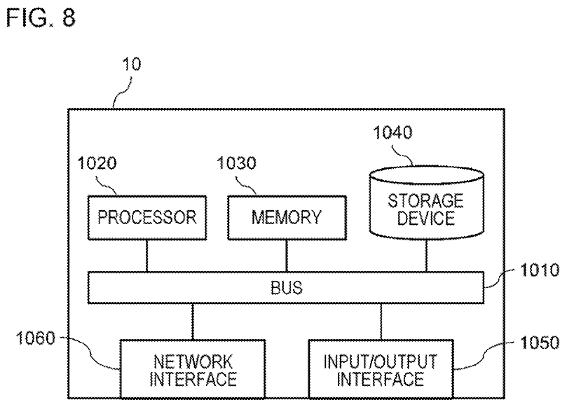

FIG. 8 is a diagram illustrating a hardware configuration example of the shop data processing apparatus 10. The shop data processing apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from one another. However, a method of mutually connecting the processor 1020 and the like is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (e.g., the sales data acquisition unit 110, the customer data acquisition unit 120, and the relevance data generation unit 130) of the shop data processing apparatus 10. The processor 1020 reads each program module on the memory 1030 and executes the read program module, and thereby each function associated to the program module is achieved. In addition, the storage device 1040 also functions as the storage unit 150.

The input/output interface 1050 is an interface for connecting the shop data processing apparatus 10 and various pieces of input/output equipment. For example, the shop data processing apparatus 10 communicates with the display 140 via the input/output interface 1050.

The network interface 1060 is an interface for connecting the shop data processing apparatus 10 to a network. The network is, for example, a local area network (LAN) or a wide area network (WAN). A method of connecting the network interface 1060 to the network may be wireless connection, or may be wired connection.

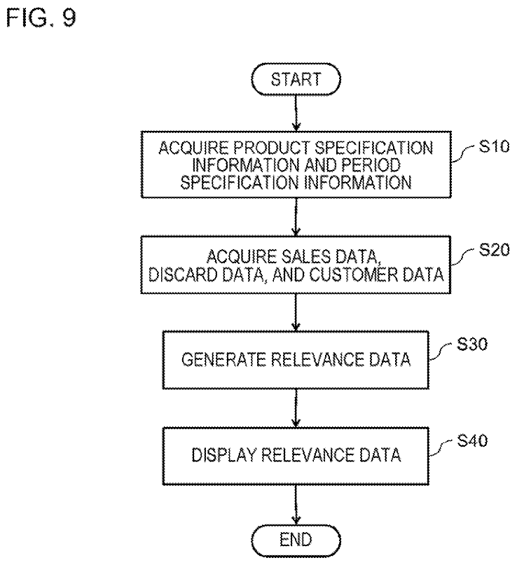

FIG. 9 is a flowchart illustrating one example of processing performed by the shop data processing apparatus 10. First, the shop data processing apparatus 10 displays an initial screen. The screen includes, for example, the period selection field 202 and the product selection field 204 illustrated in FIG. 2. A shop clerk of the first shop inputs product specification information and period specification information to the shop data processing apparatus 10 via the period selection field 202 and the product selection field 204 (step S10).

The sales data acquisition unit 110 acquires, from the storage unit 150, sales data and discard data of a product associated to the product specification information. The sales data and the discard data acquired herein are data in a period indicated by the period specification information. In addition, the customer data acquisition unit 120 acquires, from the storage unit 150, customer data in a period indicated by the period specification information (step S20).

Subsequently, the relevance data generation unit 130 generates relevance data by using the sales data, the discard data, and the customer data acquired in step S20 (step S30), and displays the relevance data on the display 140 (step S40). The shop clerk of the first shop recognizes the relevance data by viewing the display 140.

As described above, according to the present example embodiment, the shop data processing apparatus 10 generates relevance data indicating relevance among sales data, discard data, and customer data of the first shop, and displays the relevance data on the display 140. Therefore, a shop clerk of the first shop easily recognizes validity of a number of preparation of a product, for example, a number of purchases and a number of cooking.

In addition, according to the example illustrated in FIG. 5, the relevance data generation unit 130 also display, on the display 140, a recommendation number of the number of preparations of a product. Therefore, a shop clerk of the first shop further easily recognizes the validity of the number of preparations of a product. In addition, the shop clerk can also easily recognize, by viewing the display 140, whether the number of preparations of a product needs to be changed.

### Second Example Embodiment

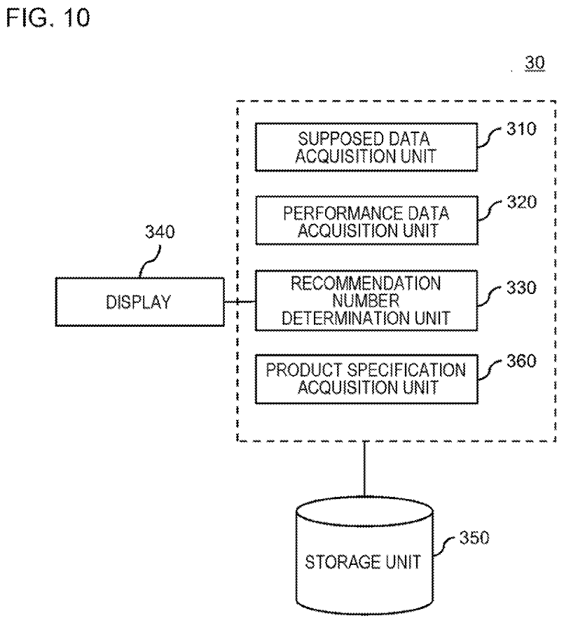

FIG. 10 is a diagram illustrating one example of a functional configuration of a shop data processing apparatus 30 according to the present example embodiment. The shop data processing apparatus 30 illustrated in the present figure computes a recommendation number described with reference to FIG. 5 of the first example embodiment, but does not generate relevance data.

Specifically, the shop data processing apparatus 30 includes a supposed data acquisition unit 310, a performance data acquisition unit 320, and a recommendation number determining unit 330.

The supposed data acquisition unit 310 acquires data including at least one of a supposed number of customers of a first shop and a supposed traffic amount of a first area in a unit period (hereinafter, referred to as a first period) in which a recommendation number is to be computed. The data are the same as supposed data described with reference to FIG. 5 in the first example embodiment. Since the first period is in future, there is no performance value of the number of customers and the traffic amount. Thus, the supposed data acquisition unit 310 computes the supposed data by using a performance value, in a past, of at least one of the number of customers and the traffic amount of the first area, similarly to the relevance data generation unit 130 of the first example embodiment. The performance used herein is a performance in a period having the same attribute as the first period.

The performance data acquisition unit 320 acquires performance data of a second shop in a second period being in the past and having the same attribute (e.g., at least one of a day of the week and a time period) as the first period.

The second shop is as described with reference to FIG. 5 in the first example embodiment. In other words, the performance data acquisition unit 320 can use a result of clustering a plurality of shops. One example of the clustering is as described with reference to FIG. 3. Then, the performance data acquisition unit 320 selects, as the second shop, at least some of shops belonging to the same cluster as the first shop.

The performance data include at least one of a performance number of customers and a performance traffic amount of a second area including the second shop, and at least one of a number of sales and a number of preparations of a product to be cooked in the second shop. Note that, a specific example of the performance data acquired by the performance data acquisition unit 320 is the same as the data used for a multiple regression analysis illustrated in FIG. 5, and is stored in a storage unit 350. Note that, the storage unit 350 also stores the same pieces of data as those in the storage unit 150 indicated in the first example embodiment.

The recommendation number determination unit 330 determines a recommendation number indicating the number of products to be prepared at the first shop in the first period, by using the supposed data and the performance data. Processing performed by the recommendation number determination unit 330 is similar to processing performed by the relevance data generation unit 130 described with reference to FIG. 5. Then, the recommendation number determination unit 330 displays the determined recommendation number on a display 340. The display performed herein is, for example, a display excluding at least one of the number of customers and the traffic amount, at least one of the number of sales and the number of preparations, and the number of discards, from the data display field 210 illustrated in FIG. 5.

Note that, the shop data processing apparatus 30 further includes a product specification acquisition unit 360 that acquires product specification information. The product specification acquisition unit 360 acquires product specification information via the product selection field 204 illustrated in FIG. 2, for example. Then, the supposed data acquisition unit 310, the performance data acquisition unit 320, and the recommendation number determination unit 330 perform the above-described processing on a product indicated by the product specification information acquired by the product specification acquisition unit 360.

According to the present example embodiment, the recommendation number determination unit 330 also display, on the display 140, the recommendation number of the number of preparations of a product. Therefore, a shop clerk of the first shop easily recognizes performance value validity of the number of preparation of a product.

Although the example embodiments of the present invention have been described above with reference to the drawings, these are exemplification of the present invention, and various configurations other than the above may be adopted.

In addition, in the plurality of flowcharts used in the above description, a plurality of steps (pieces of processing) are described in order, but the execution order of the steps executed in each example embodiment is not limited to the order described. In each of the example embodiments, the order of the steps illustrated can be changed within a range that does not interfere with the contents. Further, the above-described example embodiments can be combined within a range in which the contents do not conflict with each other.

Some or all of the above-described example embodiments may be described as the following supplementary notes, but are not limited thereto.

1. A shop data processing apparatus including:
a sales data acquisition unit that acquires sales data indicating at least one of a number of sales and a number of preparations of a product in a first shop for each unit period, and discard data indicating a number of discards of the product for the each unit period;
a customer data acquisition unit that acquires customer data indicating at least one of a number of customers of the first shop and a traffic amount of a first area including the first shop for the each unit period; and
a relevance data generation unit that generates relevance data indicating relevance among the sales data, the discard data, and the customer data, and displays the relevance data on a display.
   2. The shop data processing apparatus according to supplementary note 1 described above, wherein
the relevance data indicate a transition of at least one of the number of customers and the traffic amount, at least one of the number of sales and the number of preparations, and the number of discards.
   3. The shop data processing apparatus according to supplementary note 1 or 2 described above, wherein
the unit period is a day unit, and
the relevance data indicate, for each day of a week, at least one of the number of customers and the traffic amount, at least one of the number of sales and the number of preparations, and the number of discards.
   4. The shop data processing apparatus according to any one of supplementary notes 1 to 3 described above, wherein
the relevance data include, for the each unit period, data indicating at least one of the number of customers and the traffic amount, at least one of the number of sales and the number of preparations, and the number of discards, and
the relevance data generation unit causes a specific period being the unit period satisfying a predetermined condition to be displayed in an aspect different from another unit period.
   5. The shop data processing apparatus according to supplementary note 4 described above, wherein
the predetermined condition includes at least one of the following,
1) a ratio of at least one of the number of customers and the traffic amount, and at least one of the number of sales and the number of preparations satisfies a reference,
2) the discard data satisfy a reference,
3) it is decided that it is better to change the number of preparations.
   6. The shop data processing apparatus according to supplementary note 5 described above, wherein
the relevance data generation unit includes, in the relevance data, information being capable of determining a recommendation number of the number of preparations in the specific period.
   7. The shop data processing apparatus according to any one of supplementary notes 1 to 5 described above, wherein
the sales data acquisition unit acquires the sales data and the discard data of a second shop being different from the first shop,
the customer data acquisition unit acquires the customer data of the second shop, and
the relevance data generation unit generates the relevance data of the second shop, and displays the relevance data simultaneously with relevance data of the first shop on the display.
   8. A shop data processing apparatus including:
a supposed data acquisition unit that acquires supposed data including at least one of a supposed number of customers of a first shop and a supposed traffic amount of a first area including the first shop in a first period being in future;
a performance data acquisition unit that acquires performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
a recommendation number determination unit that determines, by using the supposed data and the performance data, a recommendation number indicating a number of the products to be prepared in the first shop in the first period.
   9. The shop data processing apparatus according to supplementary note 8 described above, wherein
the attribute includes at least one of a day of a week and a time period.
   10. The shop data processing apparatus according to supplementary note 8 or 9 described above, wherein
the supposed data acquisition unit generates the supposed data by using at least one of a performance value of a number of customers of the first shop and a performance value of a traffic amount of the first area.
   11. The shop data processing apparatus according to any one of supplementary notes 8 to 10 described above, wherein
the performance data acquisition unit
is capable of using a result of clustering a plurality of shops, and
includes a second shop selection unit that selects, as the second shop, at least some of the shops belonging to a same cluster as the first shop.
   12. The shop data processing apparatus according to any one of supplementary notes 1 to 11 described above, further including
a product specification acquisition unit that acquires product specification information specifying the product.
   13. A shop data processing method including,
by a computer to execute:
sales data acquisition processing of acquiring sales data indicating at least one of a number of sales and a number of preparations of a product in a first shop for each unit period, and discard data indicating a number of discards of the product for the each unit period;
customer data acquisition processing of acquiring customer data including at least one of a number of customers of the first shop and a traffic amount of a first area including the first shop for the each unit period; and
relevance data generation processing of generating relevance data indicating relevance among the sales data, the discard data, and the customer data, and displaying the relevance data on a display.
   14. The shop data processing method according to supplementary note 13 described above, wherein
the relevance data indicate a transition of at least one of the number of customers and the traffic amount, at least one of the number of sales and the number of preparations, and the number of discards.
   15. The shop data processing method according to supplementary note 13 or 14 described above, wherein
the unit period is a day unit, and
the relevance data indicate, for each day of a week, at least one of the number of customers and the traffic amount, at least one of the number of sales and the number of preparations, and the number of discards.
   16. The shop data processing method according to any one of supplementary notes 13 to 15 described above, wherein
the relevance data include, for the each unit period, data indicating at least one of the number of customers and the traffic amount, at least one of the number of sales and the number of preparations, and the number of discards,
the shop data processing method further including,
by the computer, in the relevance data generation processing,
causing a specific period being the unit period satisfying a predetermined condition to be displayed in an aspect different from another unit period.
   17. The shop data processing method according to supplementary note 16 described above, wherein
the predetermined condition includes at least one of the following,
1) a ratio of at least one of the number of customers and the traffic amount, and at least one of the number of sales and the number of preparations satisfies a reference,
2) the discard data satisfy a reference,
3) it is decided that it is better to change the number of preparations.
   18. The shop data processing method according to supplementary note 17 described above, further including,
by the computer, in the relevance data generation processing,
including, in the relevance data, information being capable of determining a recommendation number of the number of preparations in the specific period.
   19. the shop data processing method according to any one of supplementary notes 14 to 17 described above, further including,
by the computer:
in the sales data acquisition processing, acquiring the sales data and the discard data of a second shop being different from the second shop;
in the customer data acquisition processing, acquiring the customer data of the second shop; and,
in the relevance data generation processing, generating the relevance data of the second shop, and displaying the relevance data simultaneously with relevance data of the first shop on the display.
   20. A shop data processing method including,
by a computer to execute:
   supposed data acquisition processing of acquiring supposed data including at least one of a supposed number of customers of a first shop and a supposed traffic amount of a first area including the first shop in a first period being in future;
   performance data acquisition processing of acquiring performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
   recommendation number determination processing of determining, by using the supposed data and the performance data, a recommendation number indicating a number of the products to be prepared in the first shop in the first period.
      21. The shop data processing method according to supplementary note 20 described above, wherein
the attribute includes at least one of a day of a week and a time period.
   22. The shop data processing method according to supplementary note 20 or 21 described above, further including,
by the computer, in the supposed data acquisition processing,
generating the supposed data by using at least one of a performance value of a number of customers of the first shop and a performance value of a traffic amount of the first area.
   23. The shop data processing method according to any one of supplementary notes 20 to 22 described above, further including,
by the computer, in the performance data acquisition processing:
   being capable of using a result of clustering a plurality of shops; and
including a second shop selection unit that selects, as the second shop, at least some of the shops belonging to a same cluster as the first shop.
   24. The shop data processing method according to any one of supplementary notes 13 to 23 described above, further including,
by the computer to execute,
a product specification acquisition processing of acquiring product specification information specifying the product.
   25. A program causing a computer to include:
a sales data acquisition function of acquiring sales data indicating at least one of a number of sales and a number of preparations of a product in a first shop for each unit period, and discard data indicating a number of discards of the product for the each unit period;
a customer data acquisition function of acquiring customer data indicating at least one of a number of customers of the first shop and a traffic amount of a first area including the first shop for the each unit period; and
a relevance data generation function of generating relevance data indicating relevance among the sales data, the discard data, and the customer data, and displaying the relevance data on a display.
   26. The program according to supplementary note 25 described above, wherein
the relevance data indicate a transition of at least one of the number of customers and the traffic amount, at least one of the number of sales and the number of preparations, and the number of discards.
   27. The program according to supplementary note 25 or 26 described above, wherein
the unit period is a day unit, and
the relevance data indicate, for each day of a week, at least one of the number of customers and the traffic amount, at least one of the number of sales and the number of preparations, and the number of discards.
   28. The program according to any one of supplementary notes 25 to 27 described above, wherein
the relevance data include, for the each unit period, data indicating at least one of the number of customers and the traffic amount, at least one of the number of sales and the number of preparations, and the number of discards, and
the relevance data generation function causes a specific period being the unit period satisfying a predetermined condition to be displayed in an aspect different from another unit period.
   29. The program according to supplementary note 28 described above, wherein
the predetermined condition includes at least one of the following,
1) a ratio of at least one of the number of customers and the traffic amount, and at least one of the number of sales and the number of preparations satisfies a reference,
2) the discard data satisfy a reference,
3) it is decided that it is better to change the number of preparations.
   30. The program according to supplementary note 29 described above, wherein
the relevance data generation function includes, in the relevance data, information being capable of determining a recommendation number of the number of preparations in the specific period.
   31. The program according to any one of supplementary notes 25 to 29 described above, wherein
the sales data acquisition function acquires the sales data and the discard data of a second shop being different from the first shop,
the customer data acquisition function acquires the customer data of the second shop, and
the relevance data generation function generates the relevance data of the second shop, and displays the relevance data simultaneously with relevance data of the first shop on the display.
   32. A program causing a computer to include:
a supposed data acquisition function of acquiring supposed data including at least one of a supposed number of customers of a first shop and a supposed traffic amount of a first area including the first shop in a first period being in future;
a performance data acquisition function of acquiring performance data including at least one of a performance number of customers of a second shop and a performance traffic amount of a second area including the second shop in a second period being in a past and having a same attribute as that of the first period, and at least one of a number of sales and a number of preparations of a product to be cooked in the second shop; and
a recommendation number determination function of determining, by using the supposed data and the performance data, a recommendation number indicating a number of the products to be prepared in the first shop in the first period.
   33. The program according to supplementary note 32 described above, wherein
the attribute includes at least one of a day of a week and a time period.
   34. The program according to supplementary note 32 or 33 described above, wherein
the supposed data acquisition function generates the supposed data by using at least one of a performance value of a number of customers of the first shop and a performance value of a traffic amount of the first area.
   35. The program according to any one of supplementary notes 32 to 34 described above, wherein
the performance data acquisition function
is capable of using a result of clustering a plurality of shops, and
includes a second shop selection unit that selects, as the second shop, at least some of the shops belonging to a same cluster as the first shop.
   36. The program according to any one of supplementary notes 25 to 35 described above, further causing the computer to include:
a product specification acquisition function of acquiring product specification information specifying the product.

### REFERENCE SIGNS LIST

10 Shop data processing apparatus
30 Shop data processing apparatus
110 Sales data acquisition unit
120 Customer data acquisition unit
130 Relevance data generation unit
140 Display
150 Storage unit
310 Supposed data acquisition unit
320 Performance data acquisition unit
330 Recommendation number determination unit
340 Display
350 Storage unit
360 Product specification acquisition unit

What is claimed is:

1. A shop data processing apparatus comprising:
at least one memory configured to store one or more instructions; and
at least one processor configured to execute the one or more instructions to:
acquire sales data indicating at least one of a number of sales and a number of preparations of a product in a first shop for each unit period, and discard data indicating a number of discards of the product for the each unit period;
acquire customer data indicating at least one of a number of customers of the first shop and a traffic amount of a first area including the first shop for the each unit period; and
generate relevance data indicating relevance among the sales data, the discard data, and the customer data, and display the relevance data on a display.

2. The shop data processing apparatus according to claim 1, wherein
the relevance data indicate a transition of at least one of the number of customers and the traffic amount, at least one of the number of sales and the number of preparations, and the number of discards.

3. The shop data processing apparatus according to claim 1, wherein
the unit period is a day unit, and
the relevance data indicate, for each day of a week, at least one of the number of customers and the traffic amount, at least one of the number of sales and the number of preparations, and the number of discards.

4. The shop data processing apparatus according to claim 1, wherein
the relevance data include, for the each unit period, data indicating at least one of the number of customers and the traffic amount, at least one of the number of sales and the number of preparations, and the number of discards, and
the processor is further configured to execute the one or more instructions to cause a specific period being the unit period satisfying a predetermined condition to be displayed in an aspect different from another unit period.

5. The shop data processing apparatus according to claim 4, wherein
the predetermined condition includes at least one of the following,
1) a ratio of at least one of the number of customers and the traffic amount, and at least one of the number of sales and the number of preparations satisfies a reference,
2) the discard data satisfy a reference,
3) it is decided that it is better to change the number of preparations.

6. The shop data processing apparatus according to claim 5, wherein
the processor is further configured to execute the one or more instructions to include, in the relevance data, information being capable of determining a recommendation number of the number of preparations in the specific period.

7. The shop data processing apparatus according to claim 1, wherein the processor is further configured to execute the one or more instructions to:
acquire the sales data and the discard data of a second shop being different from the first shop,
acquire the customer data of the second shop, and
generate the relevance data of the second shop, and display the relevance data simultaneously with relevance data of the first shop on the display.

8-12. (canceled)

13. A shop data processing method comprising,
by a computer to execute:
acquiring sales data indicating at least one of a number of sales and a number of preparations of a product in a first shop for each unit period, and discard data indicating a number of discards of the product for the each unit period;
acquiring customer data indicating at least one of a number of customers of the first shop and a traffic amount of a first area including the first shop for the each unit period; and
generating relevance data indicating relevance among the sales data, the discard data, and the customer data, and displaying the relevance data on a display.

14. (canceled)

15. A non-transitory storage medium storing a program causing a computer to:
acquire sales data indicating at least one of a number of sales and a number of preparations of a product in a first shop for each unit period, and discard data indicating a number of discards of the product for the each unit period;
acquire customer data indicating at least one of a number of customers of the first shop and a traffic amount of a first area including the first shop for the each unit period; and
generate relevance data indicating relevance among the sales data, the discard data, and the customer data, and display the relevance data on a display.

16. (canceled)
